(19) United States
(12) Patent Application Publication
(10) Pub. No.: US 2007/0000436 A1
(43) Pub. Date: Jan. 4, 2007

(54) FOOD BREADING APPARATUS

(76) Inventors: Christian Zweifel, Franklin, TN (US); Brian R. Rudesill, Hudson, WI (US); Alan Keogh, Oakville (CA)

Correspondence Address: PEPPER HAMILTON LLP, ONE MELLON CENTER, 50TH FLOOR, 500 GRANT STREET, PITTSBURGH, PA, 15219, US

(21) Appl. No.: 11/427,049

(22) Filed: Jun. 28, 2006

Related U.S. Application Data
(60) Provisional application No. 60/695,049, filed on Jun. 29, 2005.

(51) Int. Cl. A23G 3/20

(52) U.S. Cl. 118/16

(57) ABSTRACT

A method and system for removing clumps from breading preparation are disclosed. Breading preparation may be placed in a tub with a plugged opening and applied to food products. When clumps form in the breading preparation, the opening may be unplugged, and the breading preparation may be directed toward the opening. A vibratory feeder receives the breading preparation, vibrates a trough, and moves the breading preparation from an input end toward an output end. Usable breading preparation is sifted through the trough, and ultimately into a tub. The clumps remain above the sifting layer and move into a different tub at the output end of the trough.

### CROSS-REFERENCE TO RELATED APPLICATIONS

This application claims priority to pending U.S. Provisional Application Ser. No. 60/695,049, filed Jun. 9, 2005, which is incorporated herein by reference in its entirety.

### TECHNICAL FIELD

This disclosure generally relates to food processing methods and systems, and, more particularly, to methods and systems for breading or otherwise coating food.

### BACKGROUND

Breaded food products are highly demanded by today's consumers. Fast food restaurants, traditional dining establishments and grocery stores each contain a variety of breaded foods. Exemplary breaded food products include chicken wings, chicken strips, chicken nuggets, chicken breasts, fish sticks, fish patties and a variety of vegetables. A breading preparation can be flour-based and can include a variety of spices depending upon the food to be breaded.

The breading process typically requires an individual to apply the breading preparation to the food in a bowl, dish or basin that contains the breading preparation. In order to adhere the breading preparation to the food, the food is typically moist. Over time, moisture can cause the breading preparation to clump together. Such clumped breading preparation is unsuitable for further use. Accordingly, from time to time, the clumps must be removed from the breading preparation.

One way to remove clumps is to discard all of the breading preparation when too many clumps occur. While this method has the advantage of removing all unusable breading preparation, it is inefficient and costly because usable breading preparation is discarded as well. Particularly for a high-volume breading operation, such as a restaurant or food processing plant, the cost of such lost materials can be excessive and prohibitive,

In order to make efficient use of usable breading preparation, systems for separating clumped breading preparation from usable breading preparation have been devised. Such systems include a perforated rotating drum, such as the one described in U.S. Pat. No. 5,265,525 to Stewart, and a brush for sweeping breading preparation, such as the one described in U.S. Pat. No. 4,952,309 to King, the disclosure of each of which is incorporated herein by reference in its entirety. However, problems exist with such devices. For example, such devices are typically too noisy to use in a place of business where customers are present, such as a restaurant. Other devices, such as those described in U.S. Pat. No. 4,936,246 to Reece, U.S. Pat. No. 3,955,529 to Reed and U.S. Pat. No. 3,910,227, the disclosure of each of which is incorporated herein by reference, use basket or hopper mechanisms that are also noisy, and which require frequent cleaning and maintenance.

Accordingly, a need exists for a method and system for removing clumps from usable breading preparation that may be operated in a place of business frequented by customers.

A further need exists for a method and system for quickly and efficiently separating usable breading preparation from unusable breading preparation.

The present embodiments are directed towards satisfying one or more of these problems.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the invention which will be limited only by the appended claims. It must also be noted that as used herein and in the appended claims, the singular forms “a,” “an,” and “the” include plural references unless the context clearly dictates otherwise.

In addition, the word “comprising” as used herein means “including but not limited to.” Unless defined otherwise, all technical and scientific terms used herein have the same meanings as commonly understood by one of ordinary skill in the art.

In one embodiment described herein, a food coating system includes a first tub having a drain, as well as a vibratory feeder. The vibratory feeder includes a vibratory device and a trough. The feeder is positioned to receive material from the drain, and the vibratory device is used to vibrate the trough such that material received in the trough moves from an input area of the trough toward an output area of the trough. The trough also includes a sifting layer, which may include mesh, slots or holes. A second tub is positioned to receive, from the output area, material that does not sift through the sifting layer when the trough is vibrated. A third tub is positioned to receive material that is sifted from the trough through the sifting layer when the trough is vibrated.

Optionally, the first tub and second tub may be removably connected to a support frame, and wherein the first tub and third tub are interchangeable. The drain may be plugged during a food coating process and unplugged when material is to be removed from the first tub. Also optionally, the system may include a delivery device that delivers material from the frame to the vibratory feeder, and the support frame may include one or more noise-dampening walls, and the support frame may include a door so that a first tub location can receive the first tub when the door is ajar.

In another embodiment, a method for removing unusable breading preparation when breading food includes: (i) applying breading preparation to one or more food products in a first tub having a plug filling an opening; (ii) removing the plug from the opening; (iii) directing the breading preparation through the opening into a vibratory feeder; (iv) replacing the plug in the opening; (v) vibrating the vibratory feeder to separate usable breading preparation from unusable breading preparation through a sifting layer of the vibratory feeder; (vi) collecting the unusable breading preparation in a second tub; and (vii) discarding the unusable breading preparation. The method may also include collecting the usable breading preparation in the first tub and reusing the usable breading preparation. Alternatively, it may include collecting the usable breading preparation in a third tub and reusing the usable breading preparation.

### BRIEF DESCRIPTION OF THE DRAWINGS

The accompanying drawings, which are incorporated in and form a part of the specification, illustrate various embodiments and together with the description, serve to explain the principles of the various embodiments.

FIG. 1 depicts a side view of an exemplary system for breading food according to an embodiment.

FIG. 2 depicts a side view of an exemplary system for breading food according to an embodiment.

FIG. 3 depicts an internal view of an exemplary system for breading food according to an embodiment.

FIGS. 4A and 4B depict a side view and a top view respectively, of an exemplary trough of a vibratory feeder according to an embodiment.

FIG. 5 depicts an exemplary lower base holder portion of a vibratory feeder attached to a vibrator motor portion of a vibratory feeder of an exemplary food breading apparatus.

FIG. 6 depicts an upper base holder portion of a vibratory feeder mounted to a trough portion of an exemplary vibratory feeder of an exemplary food breading apparatus.

FIG. 7 depicts a top view of an exemplary trough portion of a vibratory feeder comprising a mesh wire sifter.

FIG. 8 shows an assembled view of an exemplary vibratory feeder, without the mesh wire sifter, of an embodiment of a food breading apparatus.

FIG. 9 depicts an alternate embodiment of a system for breading food.

FIG. 10 depicts a flow chart for a method of breading food according to an embodiment.

### DETAILED DESCRIPTION

As used herein, a “breading preparation” is representative of any breading or other coating to be applied to a food product to be breaded. For example, a “breading preparation” may include a flour-based staple ingredient, such as white flour, corn meal, wheat flour, corn flour, and/or the like. Optionally, but not necessarily, one or more spices may be added to the staple ingredient to impart flavor to the breading preparation. It is to be understood that the above recitation of staple ingredients and spices is not meant to be limiting but only illustrative of the basic components of the breading preparation.

As used herein, a “food product” or a “product to be breaded” is representative of any product to be breaded with the breading preparation. Such products may include meats, such as chicken, beef, fish or pork, or vegetables, such as mushrooms, squash, zucchini or okra. It is to be understood that the above recitation of food products is not meant to be limiting but only illustrative of the types of products that may be breaded.

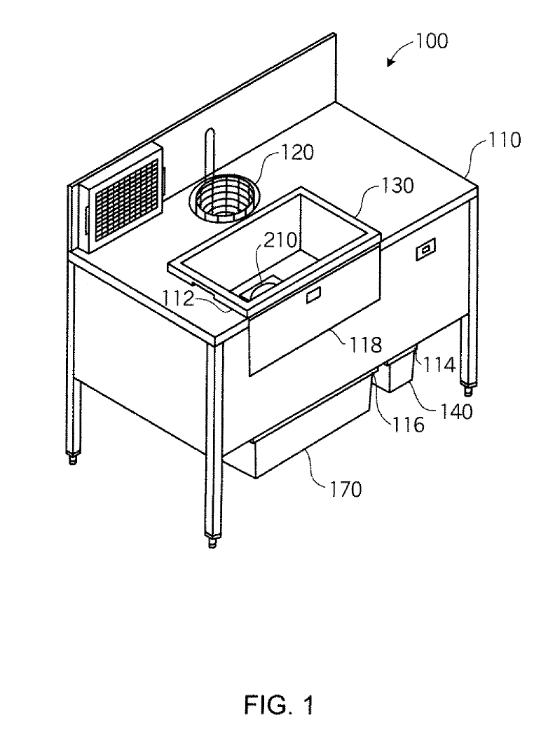

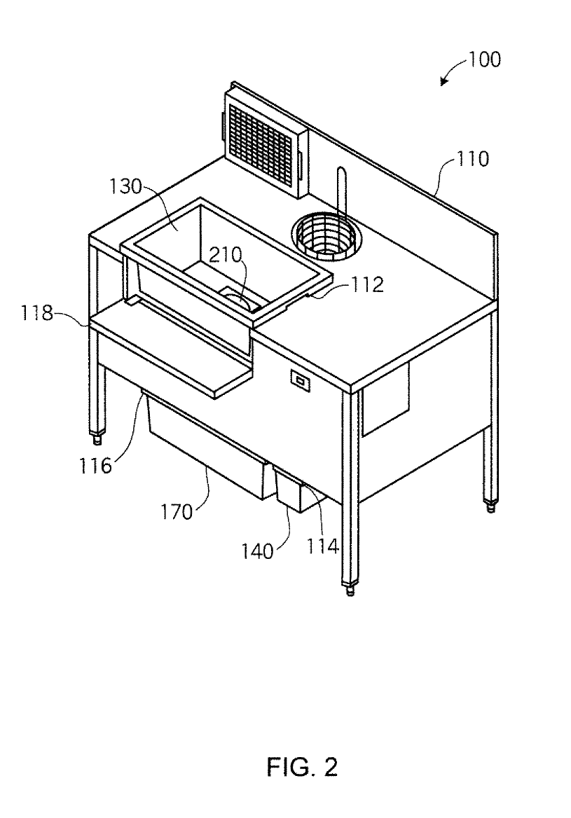

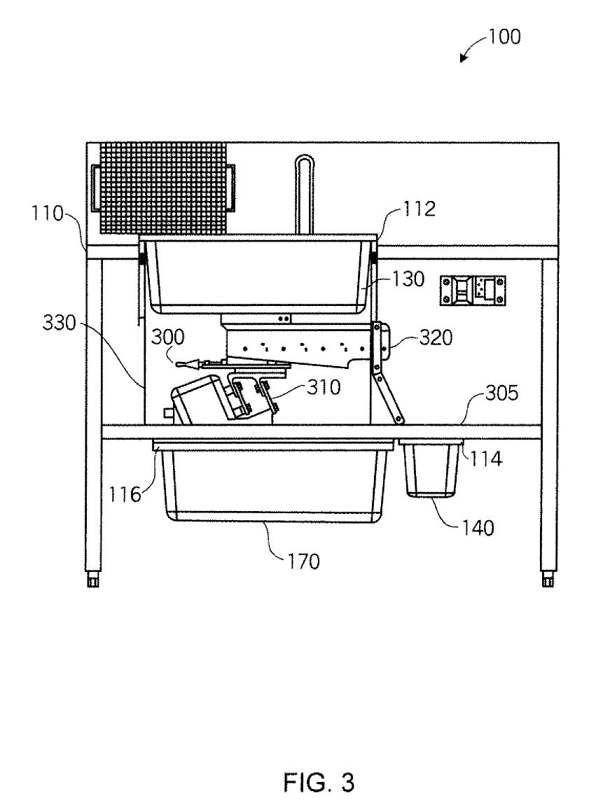

FIGS. 1 and 2 depict side views of an exemplary system for breading food according to an embodiment. As shown in FIG. 1, the food breading apparatus 100 may include a support frame 110. Food to be coated, such as chicken pieces or vegetables, may be held in a basket 120 or other suitable device. A food breading apparatus 100 may include a first tub 130, a second tub 140 and a vibratory feeder (300 in FIG. 3). As used herein, a “tub” or “receptacle” may include any vessel, device, or other structure capable of receiving and holding breading preparation. Optionally, the food breading apparatus may also include one or more walls (330 in FIG, 3) surrounding the vibratory feeder 300, a third tub 170 and/or a funnel (not shown). The first tub 130 may be used to hold a breading mixture and to bread food. The vibratory feeder 300 may receive used breading mixture from first tub 130 to separate reusable breading from clumped breading. A second tub 140 will receive clumped breading from the vibratory feed 300, while a third tub 170 (or the first tub in a location of the third tub) will receive reusable breading material. While it is possible that some clumped breading material may end up in third tub 170 and some reusable breading material will end up in second tub 140, in an embodiment those amounts may be relatively small. As used herein, a “tub” may include a tub, bucket, bowl, box, receptacle, or other item capable of receiving and holding food coating material.

The support frame 110 may provide support for the other components of the food breading apparatus 100. Be support frame 110 may include a first tub location 112, a second tub location 114 and a third tub location 116. The first tub location 112 may be on a top portion of the support frame 110. The second tub location 114 and the third tub location 116 may each be on or attached to a lower portion of support frame 110 and/or they may be internal to support frame 110. Each of the first tub location 112, the second tub location 114 and the third tub location 116 may support one or more tubs. A tub may be sized to fit within the dimensions of a corresponding tub location.

In an embodiment, the first tub location 112 may include a door 118. The door 118 may be opened so that first tub 130 may be more easily removed from the first tub location 112, as shown in FIG. 2. In an alternate embodiment, no door may be included at the first tub location 112, and a tub may be lifted from the first tub location 112 in order to remove it from the support frame 110. Alternatively, an opening may be provided in the location of door 118, but without the door. The door 118 may be connected to a hinge, latch or any suitable mechanism known to those skilled in the art that allows it to move from an open position to a closed position and be held in each position as desired.

The first tub location 112 may be sized to receive a first tub 130. In an embodiment, the first tub 130 may comprise polypropylene. However, other materials, including metals or other plastics, may be used. In an embodiment, the first tub 130 may have a drain, such as an opening 210 in its base. The opening 210 may be round, square or other-shaped and it may be of any desired size. A larger opening 210 will allow for faster removal of material from the tub through the opening, while a smaller opening may provide for a more controlled release of material. In an embodiment when desired, the opening 210 may be covered, filled or otherwise stopped up using, for example, a plug (not shown) plate other item. Any plug known to one skilled in the art that provides a barrier to reduce or inhibit the passage of materials may be used. It is to be understood that the above recitation of a plug and its size is not meant to be limiting but merely illustrative of the types or sizes of devices used to fill an opening 210

In an embodiment, a funnel tube, chute or other guide or similar device may be positioned beneath the opening 210. In an embodiment, the funnel may substantially contact the first tub 130 at the position of the opening 210 when the first tub 130 is positioned in the first tub location 112. The opening 210 and/or the funnel may be positioned above the input end of the vibratory feeder 300. However, a funnel, chute, tube or other guide is optimal, and there may be embodiments where the opening 210 simply is positioned above the vibratory feeder 300.

In an embodiment, the second tub location 114 may be sized to receive the second tub 140. In an embodiment, the second tub 140 may comprise any suitable material, such as polypropylene, metal or other material. In an embodiment, the third tub location 116 may be sized to receive the first tub 130 and/or a third tub 170. In an embodiment, the third tub 170 may comprise any suitable material, such as polypropylene, metal or other material

FIG. 3 depicts an internal view of an exemplary system for breading food according to an embodiment. In an embodiment, the support frame 110 may further include a shelf (305 in FIG. 3) for supporting the vibratory feeder 300. In an optional embodiment, the shelf 305 and/or the support frame 110 may also support one or more noise-dampening walls 330 proximate to the vibratory feeder 300. The one or more walls 330 may be used to dampen noise produced by the vibratory feeder 300. In an embodiment, the one or more walls 330 may sufficiently reduce the noise produced by the vibratory feeder 300 to permit operation of the food breading apparatus 100 in, for example, a restaurant. The walls may be made of any suitable material, such as sheet aluminum, galvanized steel or other metal or plastic. Optionally, any or all of the walls may include a noise-dampening material such as foam, rubber or sponge.

The vibratory feeder is a device that moves material from one location to another through vibration. In an embodiment, the vibratory feeder 300 may include a vibratory device 310 and a trough 320. During operation, the vibratory device 310 may be used to vibrate the trough 320.

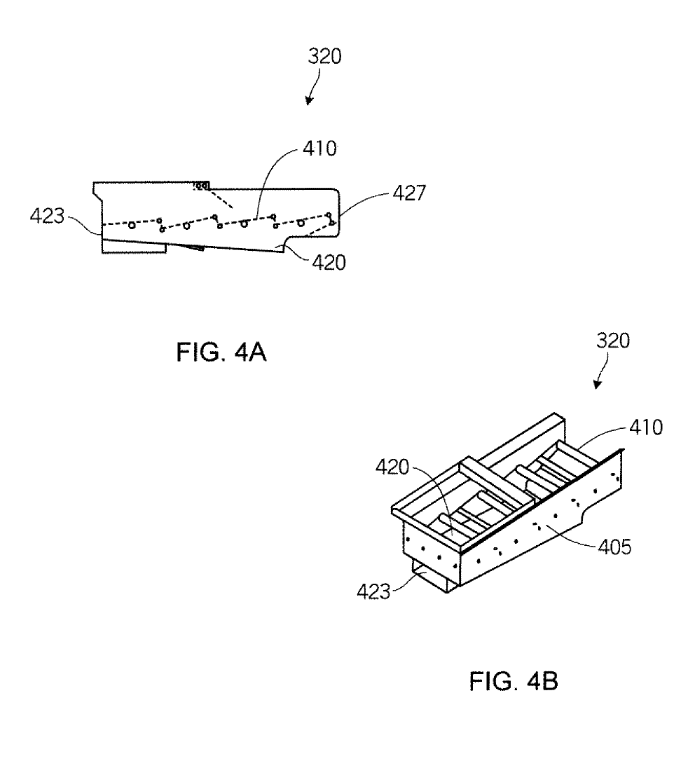

FIG. 4A depicts a side view and FIG. 4B a top view of a trough 320 of an exemplary vibratory feeder 300 according to an embodiment. The trough 320 may include one or more external walls 405, a sifting layer 410 and a collection layer 420. The trough 320 may have an input end 423 and an output end 427. The external walls 405 may surround the sifting layer 410 and the collection layer 420 on at least one side. In an embodiment, the external walls may surround the sifting layer 410 and the collection layer 420 on three sides. In an embodiment, no external wall may be located at the output end 427 of the trough 320. Thus, the trough may be a simple conveyor, a bucket mechanism or any device capable of moving material along an axis, plane or path.

In an embodiment, the vibratory feeder 300 may sift breading preparation at a rate of approximately 15 to approximately 20 pounds per minute. Other feed rates, such as approximately 1 pound per minute, approximately 5 pounds per minute, approximately 10 pounds per minute, rates in between the rates listed above, or rates higher than 20 pounds per minute are possible in various embodiments, and depending on the weight of the product being sifted. In an embodiment, the vibratory feeder 300 may be a Syntron® Electromagnetic Feeder from FMC Technologies, Inc. of Homer City, Pa. with a modified trough 320. The trough may be modified to include a sifting layer 410 described above. It is to be understood that the above recitation of the vibratory feeder 300 is not meant to be limiting but only illustrative of the types of vibratory feeders that may be used.

In an embodiment, the sifting layer 410 may include a plurality of slots. In an alternate embodiment, the sifting layer 410 may include a mesh (not shown). In an embodiment, the mesh may have openings of 0.3 mm in diameter and the opening may be placed in a 2×2 mm grid arrangement. It is to be understood that the above recitation of the sifting layer 410 is not meant to be limiting but only illustrative of sifting layer embodiments. Other mesh sizes are possible

The collection layer 420 may be located underneath the sifting layer 410. In an embodiment, the length of the collection layer 420, in the direction from the input end 423 to the output end 427, may be less than the length of the sifting layer 410. Accordingly, the end of the collection layer 420 may permit sifted material to be transferred to a tub at the third tub location 116, while non-sifted material may be transferred to the second tub 140 at the second tub location 114.

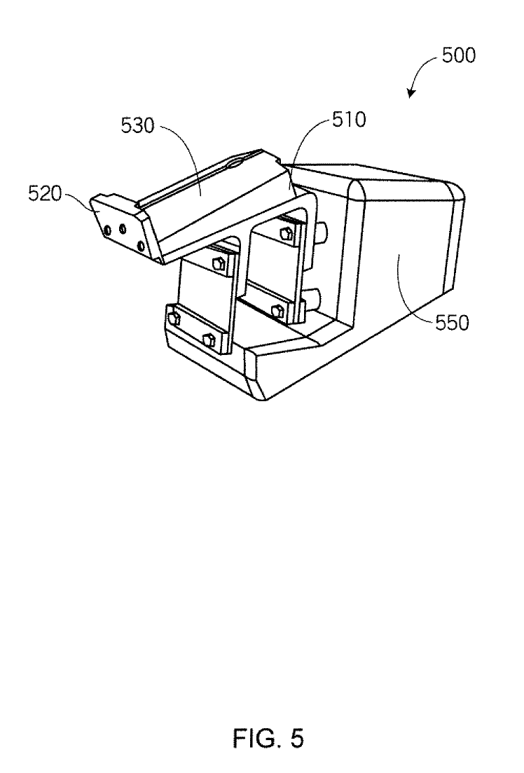

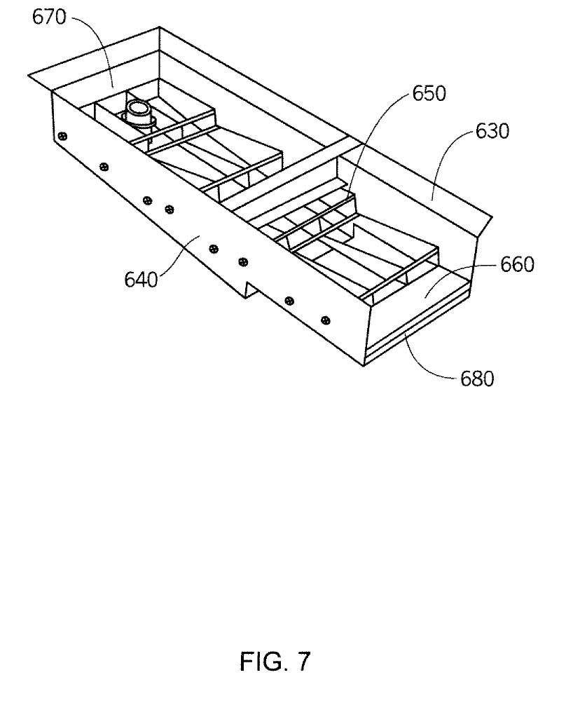

Now referring to FIGS. 5-8, an exemplary vibrator motor portion (used herein interchangeably with the phrase “vibratory device”) 500 of an exemplary vibratory feeder 800 is shown. The vibratory motor portion 500 may include a lower base portion 510. The lower base portion 510 may be an integral part of the vibratory motor portion 500, or it may be bolted, welded, or otherwise attached to the vibratory motor portion 500. It is within the scope of the embodiments herein that the lower base portion 510 may be connected to the vibrator motor portion 500 in any suitable and effective means that is now and hereafter available to one of ordinary skill in the art. The lower base portion 510 may further comprise a lower base portion wall 520, and a chamfered lower base surface 530. The lower base portion wall 520, and the chamfered lower base surface 530, may aid in the positioning and attachment of an upper base portion 610. The ease of removal and repositioning of the upper base portion 610 may be desirable for cleaning breading troughs 630, which are embodied herein.

The vibratory motor portion 500 may further comprise a motor housing 550. The motor housing 550 totally or partially encloses an electromagnetic motor (not shown). The electromagnetic motor causes the vibratory feeder 800 to vibrate, resulting in separation of used breading from unused breading. It is also recognized that any means that is know now or hereafter to cause the vibratory feeder 800 to vibrate are within the scope of the embodiments herein.

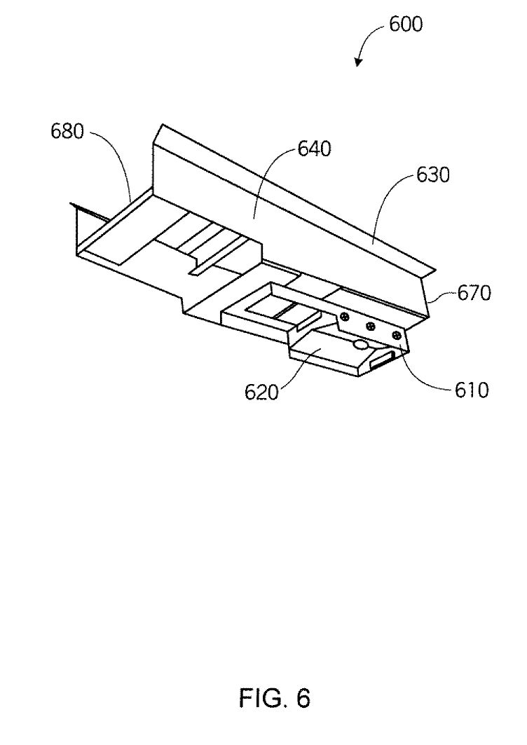

In FIG. 6, an exemplary breading trough and upper base assembly 600 is depicted. The trough and upper base assembly 600 may comprise an upper base portion 610. The upper base portion 610 may comprise a chamfered upper base surface 620. The chamfered upper base surface 620 is designed to fit snug and that is easily mated with and fastened to the chamfered lower base surface 530. In an embodiment, the trough and upper base assembly 600 further comprises a breading trough 630. The upper base portion 610 may be an integral component of the breading trough 630. Alternatively, the upper base portion 610 may be welded, bolted, or otherwise attached by any methods known now or hereafter by those of ordinary skill in the art to the breading trough 630.

The breading trough 630 of the trough and upper base assembly 600 may include one or more external walls 640, a sifting layer 650 and a collection layer 660. The trough 630 may have an input end 670 and an output end 680. The external walls 640 may surround the sifting layer 650 and the collection layer 660 on at least one side. In an embodiment, the external walls may surround the sifting layer 650 and the collection layer 660 on three sides. In an embodiment, no external wall may be located at the output end 680 of the trough 630. Thus, the trough may be a simple conveyor, a bucket mechanism or any device capable of moving material along an axis, plane or path.

In an embodiment, the vibratory feeder 800 may sift breading preparation at a rate of approximately 15 to approximately 20 pounds per minute. Other feed rates, such as approximately 1 pound per minute, approximately 5 pounds per minute, approximately 10 pounds per minute, rates in between the rates listed above, or rates higher than 20 pounds per minute are possible in various embodiments, and depending on the weight of the product being sifted. In an embodiment, the vibratory feeder 800 may be a Syntron® Electromagnetic Feeder from FMC Technologies, Inc. of Homer City, Pa. with a modified trough 630. The trough may be modified to include a sifting layer 650. In an embodiment, the sifting layer 650 may include a plurality of slots. In an alternate embodiment, the sifting layer 650 may include a mesh. In an embodiment, the mesh may have openings of 0.3 mm in diameter and the opening may be placed in a 2×2 mm grid arrangement. It is to be understood that the above recitation of the sifting layer 650 is not meant to be limiting but only illustrative of sifting layer 650 embodiments. Other mesh sizes are possible.

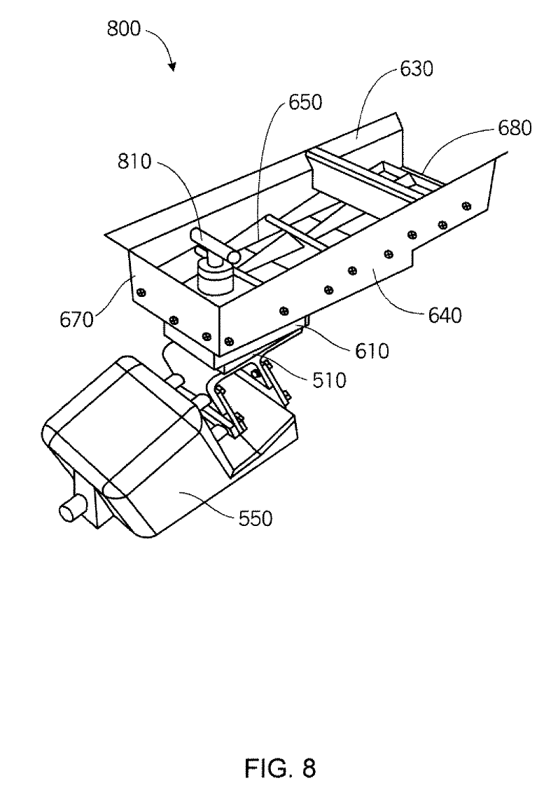

FIG. 8 depicts an exemplary embodiment of an assembled vibratory feeder 800. In an embodiment, the breading trough 630, the upper base portion 610, and the lower base portion 510, are fastened together using a bolt assembly 810. The bolt assembly 810 may comprise a nut, washer, and bolt assembly, it may consist of a bolt that fits threaded openings in the breading trough 630, the upper base portion 610, the lower base portion 510, or combinations thereof, or the bolt assembly 810 may include any fastening system that is known now or hereafter to those skilled in the art that will effectively fasten the breading trough 630, the upper base portion 610, and the lower base portion 510 and effectively maintain the fastening during vibration of the vibratory feeder 800.

It is to be understood that the above recitation of the vibratory feeder 800 is not meant to be limiting but only illustrative of the types of vibratory feeders that may be used.

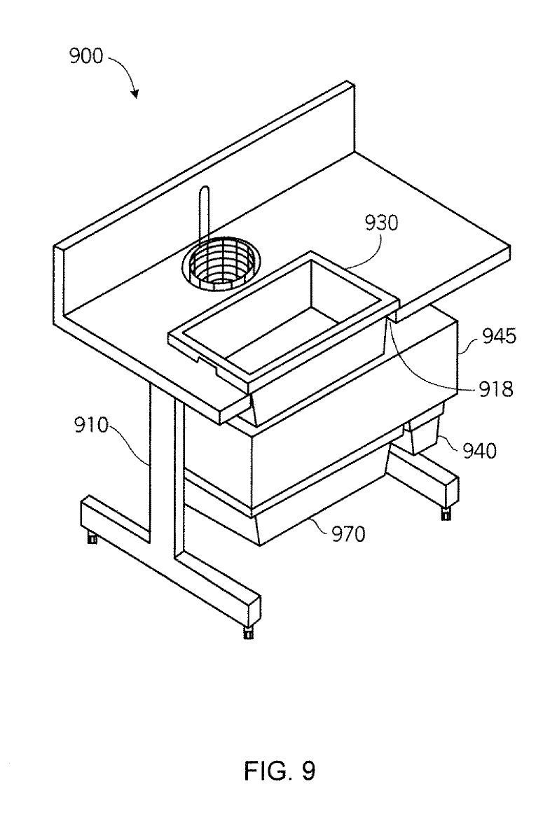

FIG. 9 illustrates an alternate embodiment of a food breading apparatus 900 with an open support frame 910. The apparatus includes a first tub 930, a second tub 940, a third tub 970 and a vibratory feeder (inside housing 945). The support frame 910 may provide support for various components of the food breading apparatus 900. The support frame may include a slot 918 into which the first tub may slide or be placed for easy placement and removal. In this embodiment, housing 945 may optionally include noise dampening walls.

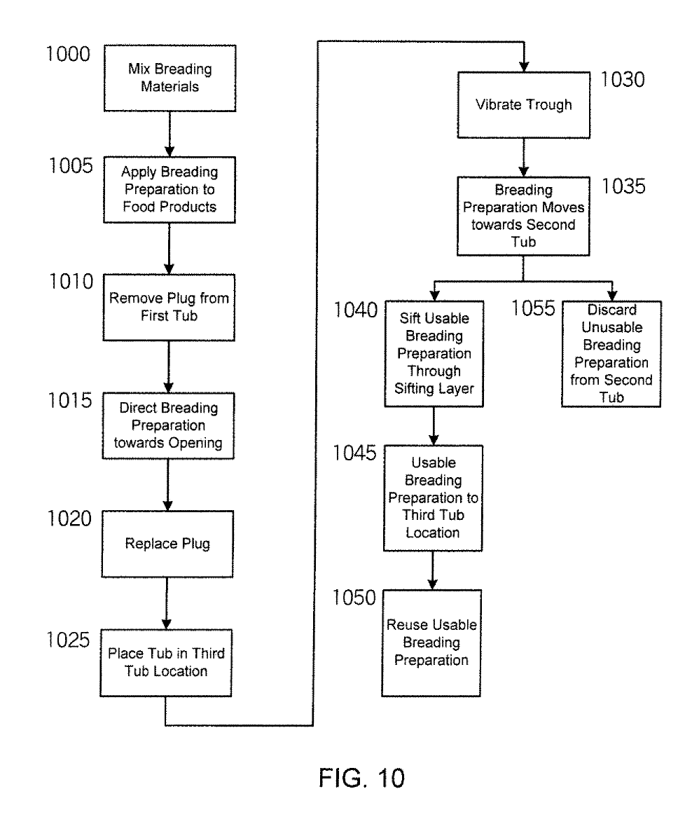

FIG. 10 depicts a flow diagram of an exemplary method of breading food according to an embodiment with reference to the exemplary device of FIG. 1. Food to be coated, such as chicken pieces or vegetables, may be held in a basket 120 or other suitable device. When the plug or plate is engaged in the opening 210, materials for a breading preparation may be placed in the first tub 130. The materials may be mixed (step 1000) in the first tub 130 and/or pre-mixed prior to being placed in the first tub 130. The operator may remove the food from basket 120 and place it in first tub 130. The breading preparation may then be applied (step 1005) to one or more food products by moving the products within the breading in the tub.

As the breading preparation is applied, moisture may cause some or all of the remaining, non-applied breading preparation in the first tub 130 to clump together. Such clumps may be unusable as breading for additional food products. When it is desired to remove the unusable breading preparation, the plug may be removed (step 1010) from the first tub 130, and the breading preparation in the first tub 130 may be directed (step 1015) towards the opening 210 by scraping, sweeping or otherwise directing the breading preparation to the opening.

Referring together to FIGS. 3 and 10, in an embodiment, while the breading preparation is directed towards the opening 210, the vibratory feeder 300 may be off. In an embodiment, when the breading preparation has been substantially removed from the first tub 130, the plug may be replaced (step 1020) in the opening 210, and the first tub 130 may be moved (step 1025) from the first tub location 112 to the third tub location 116. In an alternate embodiment, a third tub 170 may be placed (step 1025) in the third tub location 116. In such an embodiment, the vibratory feeder 300 may be on as the breading preparation in first tub 130 is directed towards the opening 210.

The input end of the trough 320 may receive some or all of the breading preparation from the opening 210 and/or the funnel. Once or as the breading preparation is received, the vibratory feeder 300 may be activated, and the trough 320 may vibrate (step 1030), The vibration may direct the breading preparation from the input end of the trough 320 towards the output area of the trough 320. As the trough 320 vibrates, the unusable breading preparation may move (step 1035) towards and, ultimately, into the second tub 140 at the second tub location 114. Moreover, referring to FIG. 4, a desired amount preferably most or substantially all of the usable breading preparation may be sifted (step 1040) through the sifting layer 410 into the collection layer 420 via the slots or mesh of the sifting layer 410. The mesh of sifting layer is not shown in FIG. 4 in order to not obscure other elements in that drawing. As shown in FIG. 4, sifting layer 410 may be stepped or graded to promote sifting of fine material while coarse material moves to the end of the trough. Ultimately, the vibration of the trough 320 may cause (step 1045) the usable breading preparation to move into the tub at the third tub location 116. As a result, the usable breading preparation may be separated from the unusable breading preparation The unusable breading preparation may then be discarded (step 1055), and the usable breading preparation may be reused (step 1050) by placing it in the first tub 130 at the first tub location 112. In an alternate embodiment, if the first tub 130 and the third tub 170 have compatible designs, the tubs may be interchanged.

It is to be understood that the invention is not limited in its application to the details of construction and to the arrangements of the components set forth in this description or illustrated in the drawings. The disclosed method and system are capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the disclosed embodiments.

What is claimed is:

1. A food coating system comprising:
a first tub, wherein the first tub has a drain;
a vibratory feeder, positioned to receive material from the drain, comprising a vibratory device and a trough, wherein the vibratory device is used to vibrate the trough such that material received in the trough moves from an input area of the trough toward an output area of the trough, and wherein the trough comprises a sifting layer;
a second tub positioned to receive, from the output area, material that does not sift through the sifting layer when the trough is vibrated; and
a third tub positioned to receive material that is sifted from the trough through the sifting layer when the trough is vibrated.

2. The system of claim 1 wherein the first tub and second tub are removably * connected to a support frame, and wherein the first tub and third tub are interchangeable.

3. The system of claim 1 wherein the drain is plugged during a food coating process and unplugged when material is to be removed from the first tub.

4. The system of claim 1 further comprising a delivery device that delivers material from the frame to the vibratory feeder.

5. The system of claim 2 wherein the support frame includes one or more noise-dampening walls.

6. The system of claim 1 wherein the sifting layer comprises a plurality of slots.

7. The system of claim 1 wherein the sifting layer comprises a mesh.

8. The system of claim 2 wherein the support frame includes a door, wherein a first tub location can receive the first tub when the door is ajar.

9. The system of claim 1 wherein the vibratory feeder further comprises:
a lower base portion wherein the lower base portion comprises a chamfered lower base surface;
an upper base portion wherein the upper base portion comprises an chamfered upper base surface; and
the chamfered upper base surface mates with and fastens to the chamfered lower base surface.

10. A method for removing unusable breading preparation when breading food, the method comprising:
applying breading preparation to one or more food products in a first tub having a plug filling an opening;
removing the plug from the opening;
directing the breading preparation through the opening into a vibratory feeder;
replacing the plug in the opening;
vibrating the vibratory feeder to separate usable breading preparation from unusable breading preparation through a sifting layer of the vibratory feeder;
collecting the unusable breading preparation in a second tub; and
discarding the unusable breading preparation.

11. The method of claim 10, further comprising:
collecting the usable breading preparation in the first tub; and
reusing the usable breading preparation.

12. The method of claim 10, further comprising:
collecting the usable breading preparation in a third tub; and
reusing the usable breading preparation.

13. A food coating system comprising:
a food coating tub;
a vibratory device positioned to receive coating material from the tub, wherein the vibratory device includes a sifting layer that passes fine coating material but blocks non-fine coating material from passing; and
a receptacle that receives, from the vibratory device, fine coating material that has been passed through the sifting layer.

14. The system of claim 13 wherein the vibratory feeder further comprises:
a lower base portion wherein the lower base portion comprises a chamfered lower base surface;
an upper base portion wherein the upper base portion comprises an chamfered upper base surface; and
the chamfered upper base surface mates with and fastens to the chamfered lower base surface.

15. The system of claim 13, further comprising a second receptacle that receives, from the vibratory device, material that has not passed through the sifting layer.

16. The system of claim 13, wherein the food coating tub and the receptacle are interchangeable.

17. The system of claim 13, wherein the food coating tub has a drain.

18. The system of claim 13, wherein the sifting layer comprises a mesh.

19. The system of claim 13 wherein the first tub and second tub are removably connected to a support frame.

20. The system of claim 19 wherein the support frame includes one or more noise-dampening walls.
